(19) United States
(12) Patent Application Publication
(10) Pub. No.: US 2007/0217376 A1
(43) Pub. Date: Sep. 20, 2007

(54) Authentication of wireless access nodes

(75) Inventor: Daniel Harkins, LaSelva Beach, CA (US)

Correspondence Address: Tropos Networks Patent Dept, PO Box 641867, San Jose, CA, 95164-1867, US

(73) Assignee: Tropos Networks, Inc.

(21) Appl. No.: 11/384,683

(22) Filed: Mar. 20, 2006

(51) Int. Cl. H04Q 7/24

(52) U.S. Cl. 370/338

(57) ABSTRACT

A method and apparatus of a first wireless access node authenticating a second wireless access node is disclosed. The method includes the first wireless access node receiving a network advertisement from the second wireless access node, and the first wireless access node interrogating the second wireless access node by transmitting an A token. If the first wireless access node receives a response from the second wireless access node to the A token, and the response includes a B token which is cryptographically bound to the A token, and cryptographically bound to the first wireless access node and the second wireless access node, and a shared secret, then the first access node identifies the second wireless access node as friendly.

### FIELD OF THE INVENTION

The invention relates generally to wireless communication. More particularly, the invention relates to an apparatus and method for authentication of wireless access nodes.

### BACKGROUND OF THE INVENTION

Wireless mesh networks can be quickly and inexpensively deployed because they do not require as much infrastructure as wired networks. However, wireless networks can be susceptible to security breaches. For example, a wireless version of email phishing scam has emerged in which an attacker tricks wireless users into connecting a laptop or personal digital assistant (PDA) to a rogue hotspot by posing as a legitimate provider. Once the victim has connected to the illegitimate hotspot, the attacker can gain access to the user's log-on details, along with personal and confidential information that aids in identity theft and other illegal activities.

FIG. 1 shows a wireless network. The network includes wireless access nodes 130, 140, 150, 160, 170 that provide data paths between clients 180, 190 and gateways 110, 120. The gateways 110, 120 are connected to a wired network 105 which can be connected to the internet 100.

FIG. 1 also shows an illegitimate access node 195, also referred to as an “evil twin”. The illegitimate access node 195 can be set up so that a client (typically, a laptop or PDA) connects to a rogue network and is then routed to a real network. In the process, the evil twin hacker associated with the illegitimate access node 195 can see all information that is being sent and received by the user. For example, the illegitimate access node 195 can be set up so that the client 180 connects to a rogue signal of the illegitimate access node 195, and the illegitimate access node then routes that signal through to the access node 140. The illegitimate access node can then monitor all communication between the client 180 and the access node 140.

An illegitimate access node 195 can also lure a client away from a legitimate wireless access node, and therefore, tap into the client base of the network associated with the legitimate access node. The result be a reduced client base for the legitimate network, and an increase client base for the illegitimate network.

Prior art method of identifying illegitimate access nodes includes a central management system knowing all valid access points. If a first access node identifying a second access node that is advertising the network associated with the first access node, the first access node informs the central management system. The central management system then checks a database of valid access points. If the second wireless access node is within the database of valid access points, then the central management system ignores the notification from the first access node. Otherwise, the central management system issues an alert identifying the evil twin. However, if there is not a central management system available, this method fails.

The 802.11 standard includes a wired equivalent privacy (WEP) algorithm. WEP provides a means for protecting authorized user of a wireless LAN from casual eavesdropping. Shared-key authorization makes use of WEP. 802.11 requires that any stations implementing WEP also implement shared-key authentication. Shared-key authentication requires that a shared key be distributed to stations before authentication.

It is desirable for wireless networks to be able to identify and designate illegitimate access nodes. It is additionally desirable that the wireless networks be resistant to attacks by illegitimate access nodes.

### SUMMARY OF THE INVENTION

A method and apparatus for identifying illegitimate access nodes is disclosed. The method and apparatus enable wireless mesh networks to identify and designate illegitimate wireless access nodes.

An embodiment of the invention includes a method of a first wireless access node authenticating a second wireless access node. The method includes the first wireless access node receiving a network advertisement from the second wireless access node, and the first wireless access node interrogating the second wireless access node by transmitting an A token. If the first wireless access node receives a response from the second wireless access node to the A token, and the response includes a B token which is cryptographically bound to the A token, and cryptographically bound to the first wireless access node, the second wireless access node and a shared secret, then the first access node identifies the second wireless access node as friendly.

Another embodiment of the invention includes a method of wireless access node verification. This method includes a first wireless access node receiving a network advertisement from a second wireless access node, and the first wireless access node interrogating the second wireless access node by transmitting an A token. The second wireless access node responding by transmitting a B token that is cryptographically bound to the A token, proof that the second wireless access node knows the A token, cryptographic binding and a shared secret. The first wireless access node verifies the response, and designates the second wireless access node as either legitimate or as an evil twin.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless mesh network that includes an illegitimate wireless access node.

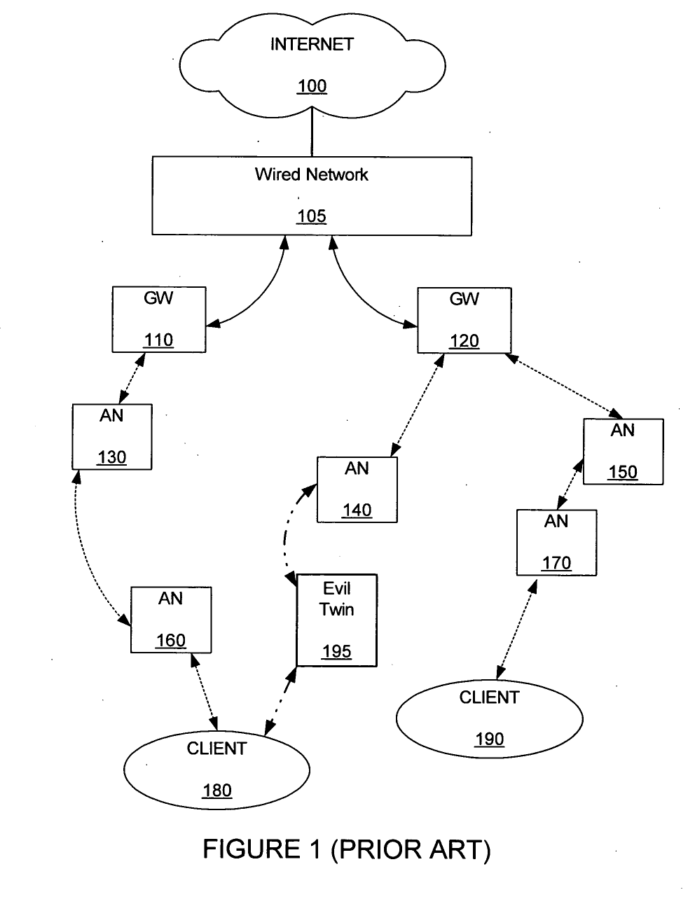

FIG. 2 shows an exemplary method an access node of identifying illegitimate wireless access nodes.

FIG. 3 shows a more detailed exemplary method of an access node identifying illegitimate wireless access nodes.

FIG. 4 shows an exemplary method a wireless network identifying illegitimate wireless access nodes.

FIG. 5 shows wireless networks that can utilize the methods of identifying illegitimate wireless access nodes.

### DETAILED DESCRIPTION

The invention includes an apparatus and methods of identifying illegitimate access nodes. The method and apparatus enable wireless mesh networks to identify and designate illegitimate wireless access nodes.

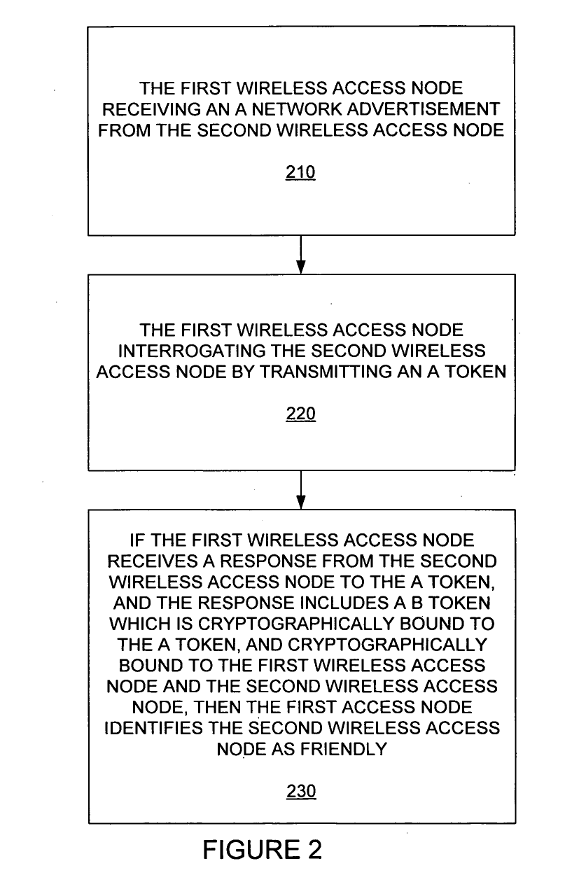

FIG. 2 shows an exemplary method of identifying illegitimate wireless access nodes. More specifically, FIG. 2 shows a method of a first wireless access node authenticating a second wireless access node. A first step 210 of the method comprises the first wireless access node receiving a network advertisement from the second wireless access node. A second step 220 includes the first wireless access node interrogating the second wireless access node by transmitting an A token. A third step 230 includes if the first wireless access node receives a response from the second wireless access node to the A token, and the response includes a B token which is cryptographically bound to the A token, and cryptographically bound to the first wireless access node, the second wireless access node and a shared secret, then the first access node identifies the second wireless access node as friendly.

Network Advertisements

Access nodes of the wireless network advertise availability by broadcasting beacons. Clients that receive these beacons select an advertised network when seeking association with the wireless network.

Interrogation

In response to receiving the network advertisement from the second wireless access node, the first wireless access node interrogates the second wireless access node. In a general sense, interrogation includes the first access node requesting from the second access node the answer to a question that only a valid node can answer. The question is requested in a way that ensures that an illegitimate node can not determine a secret of the nodes by observing (receiving and evaluating) the interrogation.

An exemplary interrogation process begins by the first wireless access node choosing a random number N_{A}. The first wireless access node then wraps N_{A} with a secret number k (the shared secret). Wrapping can be depicted by {N_{A}}ₖ, and includes encrypting and integrity protecting N_{A} with k. The first wireless access node then sends (transmits) {N_{A}}ₖ to the second wireless access node.

The shared secret is data only known by valid access nodes. The shared secret can be, for example, a number or phrase.

Response by the Second Wireless Access Node

Generally, the second wireless access node proves it is a valid access node by providing proof that it knows the secret.

Under normal operation, an exemplary embodiment includes the second wireless access node receiving {N_{A}}ₖ. The second wireless access node then unwraps {N_{A}}ₖ, which includes decrypting and verifying N_{A}. Only node that know the secret number k (shared secret) can successfully unwrap {N_{A}}ₖ. If the verification fails, then the process stops. If the decryption and verification is successful, then the second wireless access node chooses a random number N_{B}, and wraps N_{B} with the secret k. The second wireless access node then generates cryptographic binding D, which includes setting D to:

D=H(N_{A}|N_{B}, ID_{A}|ID_{B}), where d=H(x,y) is a keyed hashing function with x as the input key, and y is the data to hash, and producing a digest d, and x|y is a concatenation of x with y.

The first wireless access node has an ID (identification) of ID_{A}. The second wireless access node has an ID (identification) of ID_{B}.

The second wireless access node then sends (transmits) {N_{B}}ₖ and D to the first wireless access node.

The B token as described, can include the wrapping random number {N_{B}}ₖ and the cryptographic binding D.

Identification as a Friendly Access Node

If the first wireless access node does not receive any responses to the interrogation, then the first access node identifies the second wireless access node as illegitimate, and designates it as an evil twin. The first wireless access node can send some set number of interrogation response before making the designation. An exemplary number of interrogations can be any number that is determined to be reasonable. However, if the first wireless access node does receive a response which includes the {N_{B}} and D (cryptographic binding) from the second wireless access node, the first wireless access node goes through a verification process. The process includes unwrapping the random number N_{B}. An exemplary embodiment of unwrapping the random number N_{B} includes decrypting and verifying N_{B}. Decrypting and verifying includes decrypting ciphertext using a key k, and performing a cryptographic data integrity check using the key k. An exemplary type of wrapping includes an AES keywrap.

If the verification fails, then the second wireless access node is identified as an evil twin.

The first wireless access node then verifies the cryptographic binding by calculating:
V=H(N_{A}|N_{B}, ID_{A}|ID_{B}).

If V is equal to D, then the second wireless access node is designated as a friendly node. If V is not equal to D, then the second wireless access node is designated as an evil twin (illegitimate).

The verification of the cryptographic binding can include hashing of components of the A and B tokens, and the ID of the first wireless access node and the ID of the second wireless access node. The verification can further include comparing the hashing of components of the A and B tokens, and the ID of the first wireless access node and the ID of the second wireless access node with the cryptographic binding received from the second access node.

Illegitimate Access Node

Generally, if the response from the second wireless access node does not include a B token, or the B token is not cryptographically bound to the A token, or the B token is not cryptographically bound to the first wireless access node and the second wireless access node, or the B token does not have a component wrapped with the secret k, then the first wireless access node identifies the second wireless access node as an evil twin.

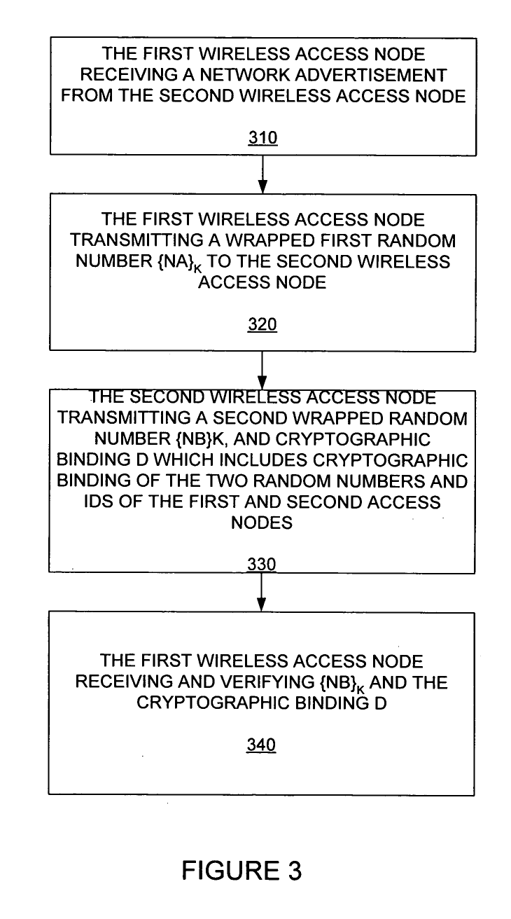

FIG. 3 shows a more detailed exemplary method of identifying illegitimate wireless access nodes. A first step 310 of the method comprises the first wireless access node receiving a network advertisement from the second wireless access node. A second step 320 includes the first wireless access node transmitting a wrapped first random number {N_{A}}ₖ to the second wireless access node. A third step 330 includes the second wireless access node transmitting a second wrapped random number {N_{B}}ₖ, and cryptographic binding D which includes cryptographic binding of the two random numbers and IDs of the first and second access nodes. A fourth step 340 includes the first wireless access node receiving and verifying {N_{B}}ₖ and the cryptographic binding D.

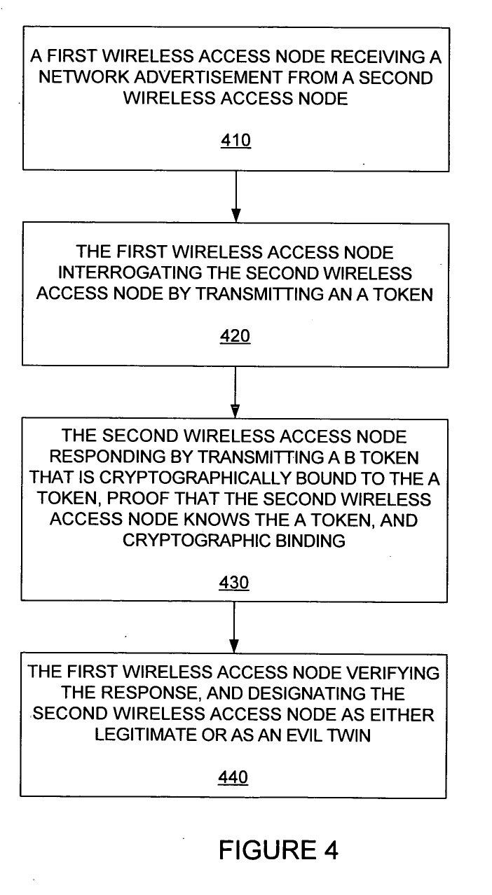

FIG. 4 shows an exemplary method a wireless network identifying illegitimate wireless access nodes. A first step 410 of the method includes a first wireless access node receiving a network advertisement from a second wireless access node. A second step 420 includes the first wireless access node interrogating the second wireless access node by transmitting an A token. A third step 430 includes the second wireless access node responding by transmitting a B token that is cryptographically bound to the A token, proof that the second wireless access node knows the A token, and cryptographic binding. A fourth step 440 includes the first wireless access node verifying the response, and designating the second wireless access node as either legitimate or as an evil twin.

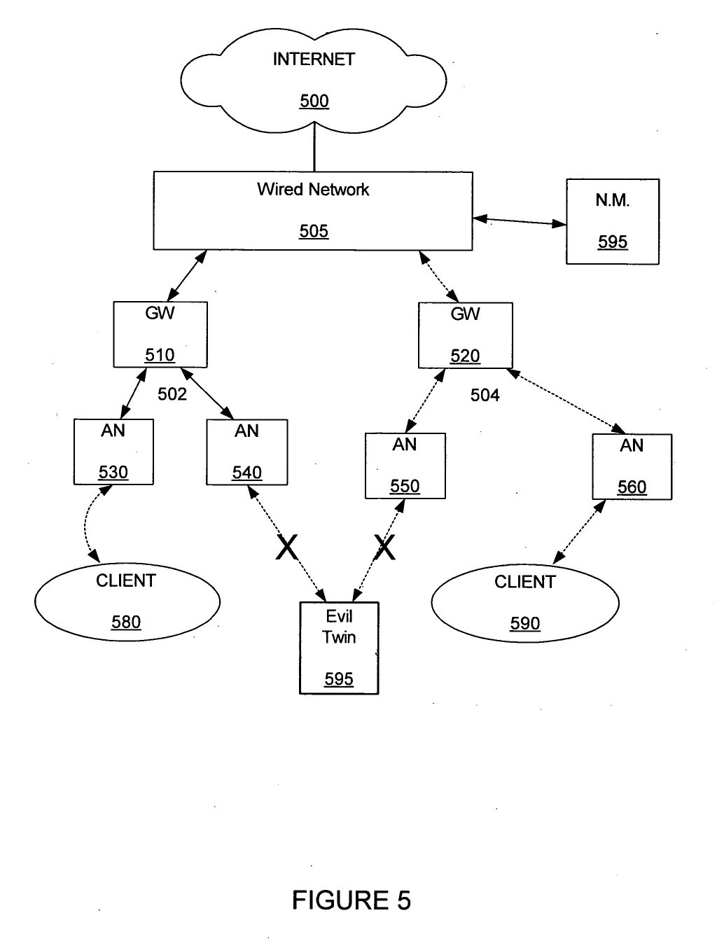

FIG. 5 shows wireless networks that can utilize the methods of identifying illegitimate wireless access nodes. A first network 502 includes access nodes that are wired to gateways. A second network 504 includes access nodes that are wirelessly connected to gateways, and form at least part of a wireless mesh network. The first network 502 includes a gateway 510 and access nodes 530, 540. The second network 504 includes a gateway 520 and access nodes 550, 560. The networks 502, 504 are provided as examples of at least portions of wireless networks. Each of these networks 502, 504 can include any number of gateways and any number of access nodes.

As shown, a first client 580 can access the internet 500 by wirelessly connecting to, for example, access node 530. Access node 530 is wire connected (for example, but could be wireless) to the gateway 510 which is connected to the internet through a wired network 505.

As shown, a second client 590 can access the internet 500 by wirelessly connecting to, for example, access node 560. Access node 560 is wirelessly connected (for example, but could be wired) to the gateway 520 which is connected to the internet through a wired network 505. The connection between the gateway 520 and the wired network 505 can be wired or wireless.

The methods of identifying illegitimate access nodes, such as, an evil twin 595, can be incorporated on each of the access nodes 530, 540, 550, 560. As shown, the access nodes of the network identify the evil twin 595. The access nodes can then inform a network manager 595 of the existence of the evil twin 595.

Security Provided

The methods of FIGS. 2, 3, 4 allow access points to interrogate other access points to verify that the other access point shares a secret, and therefore, whether the other access point is valid.

The methods do not require a complete list of all valid access point which needs to be continually updated. This is desirable because these methods do not require the overhead and complexity required of other methods that do require a complete list of valid access points.

Generally, proof of possession of the key k means you are not an illegitimate access node. The addition of a new access node to the wireless network requires the new access node to provide k. If there are N access nodes within the network before the addition of the new access node, it is not necessary to inform all N existing access nodes that the new access node is valid. The addition of the new access node requires one operation, not N operations. That is, the number of operations required to add a new access node is the same no matter how many other access nodes exist in the network.

It is not possible to learn the shared secret by observing the verification interactions between access nodes. For the earlier provided exemplary embodiment, the numbers N_{A} and N_{B} are random. Therefore, there is no information available to illegitimate listening nodes with which to derive the secret key k. There are virtually an infinite possibility of random numbers and random secret keys k that produce the wrapped numbers that are transmitted.

Furthermore, the shared secret can not be obtained by launching a dictionary attack. During operation, there is nothing that an illegitimate attacking node can observe to launch a dictionary attack. To launch a dictionary attack, it is necessary to know H(k, N_{A}) and N_{A} and then to try all possible dictionary entries as a key k until the attacker is successful in producing a match However, an observable N_{A} is never sent.

Additionally, the access nodes of the network can not be fooled into revealing the shared secret through false interrogations. Valid access nodes always use a random number, such as N_{B}, in response to an interrogation. If an attacking illegitimate access node observes a valid interrogation and attempts to replay the observed response, the response will always be invalid. The information required to determine the secret key k is not provided in the exchanges between the access nodes.

WEP implemented systems do no provide for a response that includes a B token which is cryptographically bound to the A token, and cryptographically bound to the first wireless access node and the second wireless access node.

An attacking invalid access node that generates and sends a random number as if it is a random number wrapped with a key k, is rejected because a data integrity check of the number will fail because the number is not actually wrapped with the secret key k.

Although specific embodiments of the invention have been described and illustrated, the invention is not to be limited to the specific forms or arrangements of parts so described and illustrated. The invention is limited only by the appended claims.

What is claimed:

1. A method of a first wireless access node authenticating a second wireless access node comprising:
the first wireless access node receiving a network advertisement from the second wireless access node;
the first wireless access node interrogating the second wireless access node by transmitting an A token;
if the first wireless access node receives a response from the second wireless access node to the A token, and the response includes a B token which is cryptographically bound to the A token, and cryptographically bound to the first wireless access node and the second wireless access node, and a shared secret, then the first access node identifies the second wireless access node as friendly.

2. The method of claim 1, further comprising:
if the response from the second wireless access node does not include a B token, or the B token is not cryptographically bound to the A token, or the B token is not cryptographically bound to the first wireless access node and the second wireless access node, then the first wireless access node identifies the second wireless access node as an evil twin.

3. The method of claim 1, wherein the B token being cryptographically bound to the first access node and the second access node comprises the B token being cryptographically bound to an ID of the first access node and an ID of the second access node.

4. The method of claim 1, wherein once the first wireless access node identifies the second wireless access node as an evil twin, the first access node conveys this to a network manager.

5. The method of claim 1, wherein the response from the second access node includes cryptographic binding of the B token to the A token, and cryptographic binding of the B token to an ID of the first wireless access node and to an ID of the second wireless access node.

6. The method of claim 1, wherein determining the A token comprises:
the first wireless access node choosing a random number N_{A};
wrapping N_{A} with k, wherein k is a secret number.

7. The method of claim 6, wherein wrapping N_{A} with k comprises encrypting and integrity protecting N_{A} with k.

8. The method of claim 1, wherein the first wireless access node evaluating the response from the second wireless access node comprises:
unwrapping a random number N_{B}.

9. The method of claim 8, wherein unwrapping the random number N_{B} comprises:
decrypting and verifying N_{B}.

10. The method of claim 8, wherein the random number N_{B} is selected by the second wireless access node.

11. The method of claim 5, wherein verifying the cryptographic binding of the second wireless access node comprises:
hashing of components of the A and B tokens, and the ID of the first wireless access node and the ID of the second wireless access node.

12. The method of claim 11, wherein verifying the cryptographic binding of the second wireless access node further comprises:
comparing the hashing of components of the A and B tokens, and the ID of the first wireless access node and the ID of the second wireless access node with the cryptographic binding received from the second access node.

13. A method of wireless access node verification comprising:
a first wireless access node receiving a network advertisement from a second wireless access node;
the first wireless access node interrogating the second wireless access node by transmitting an A token;
the second wireless access node responding by transmitting a B token that is cryptographically bound to the A token, proof that the second wireless access node knows the A token, and cryptographic binding;
the first wireless access node verifying the response, and designating the second wireless access node as either legitimate or as an evil twin.

14. The method of claim 13, wherein the cryptographic binding comprises cryptographic binding of the B token to the A token, and cryptographic binding of the B token to an ID of the first wireless access node and to an ID of the second wireless access node.

15. The method of claim 14, wherein verifying the response comprises:
hashing of components of the A and B tokens, and the ID of the first wireless access node and the ID of the second wireless access node.

16. The method of claim 15, wherein verifying the response of the second wireless access node further comprises:
comparing the hashing of components of the A and B tokens, and the ID of the first wireless access node and the ID of the second wireless access node with the cryptographic binding received from the second access node.

17. A wireless network, comprising a plurality of wireless access nodes, each access node comprising:
means for receiving a network advertisement from the second wireless access node;
means for node interrogating the second wireless access node by transmitting an A token;
if the first wireless access node receives a response from the second wireless access node to the A token, and the response includes a B token which is cryptographically bound to the A token, and cryptographically bound to the first wireless access node and the second wireless access node, then means for identifying the second wireless access node as friendly.

18. The network for claim 17, each access node further comprising:
if the response from the second wireless access node does not include a B token, or the B token is not cryptographically bound to the A token, or the B token is not cryptographically bound to the first wireless access node and the second wireless access node, then means for identifying the second wireless access node as an evil twin.

19. The network of claim 17, wherein the response from the second access node includes cryptographic binding of the B token to the A token, and cryptographic binding of the B token to an ID of the first wireless access node and to an ID of the second wireless access node.

20. The network of claim 19, wherein verifying the cryptographic binding of the second wireless access node comprises:
comparing hashing of components of the A and B tokens, and the ID of the first wireless access node and the ID of the second wireless access node with the cryptographic binding received from the second access node.

21. The network of claim 17, wherein the network is a wireless mesh network and the first wireless access nodes and the second wireless access node are at least one wireless hop away from a gateway.

22. The network of claim 21, wherein the first wireless access nodes alerts a network manager of the wireless mesh network if the first wireless access node identifies an illegitimate access node.

23. A method of a first wireless access node authenticating a second wireless access node comprising:
the first wireless access node receiving a network advertisement from the second wireless access node;
the first wireless access node choosing a random number N_{A};
the first wireless access node wrapping the random number N_{A} with a secret number k;
the first wireless access node transmitting the wrapped the random number {N_{A}}ₖ;
the second wireless access node receiving the wrapped the random number {N_{A}}ₖ;
the second wireless access node unwrapping {N_{A}}ₖ;
the second wireless access node decrypting and verifying N_{A};
if the verification is successful, the second wireless access node choosing and wrapping a random number N_{B};
the second wireless access node generating a cryptographic binding D;
the second wireless access node transmitting the wrapped random number {N_{B}}ₖ;
the first wireless access node receiving the cryptographic binding and the wrapped random number {N_{B}}ₖ;
the first wireless access node unwrapping, decrypting and verifying N_{B};
the first wireless access node verifying the cryptographic binding D;
the first wireless access node identifying the second wireless access node as an evil twin if either of the verifications fail.
